(19) United States
(12) Patent Application Publication
(10) Pub. No.: US 2015/0161619 A1
(43) Pub. Date: Jun. 11, 2015

(54) VERIFYING A BUSINESS LISTING BASED ON PHOTOGRAPHIC BUSINESS LISTING INFORMATION OBTAINED THROUGH IMAGE RECOGNITION

(71) Applicant: Baris Yuksel, New York, NY (US)

(72) Inventor: Baris Yuksel, New York, NY (US)

(73) Assignee: GOOGLE INC., Mountain View, CA (US)

(21) Appl. No.: 13/344,109

(22) Filed: Jan. 5, 2012

(51) Int. Cl. G06Q 30/00; G06Q 99/00

(52) U.S. Cl. CPC G06Q 30/0185

(57) ABSTRACT

An apparatus for verifying the authenticity of a potentially false business listing is provided. The apparatus may include a memory that stores a plurality of business types and a plurality of business listings. The business types may identify one or more spam business types. The apparatus may further include a processor in communication with the memory that identifies a selected one of the business listings as a potentially false business listing when the business type of the selected business listing is identified as one of the spam business listing types. The apparatus may then communicate a request for a photograph of a business corresponding to the identified business listing and extract photographic business listing information from the requested photograph. When the extracted photographic business listing information does not match the identified business listing, the apparatus may remove the business listing from the plurality of business listings.

### BACKGROUND

When a user desires to find a business, such as a plumbing service, a law firm, a doctor, or other such business, the user may turn to the Internet to conduct an online search for the business. In many instances, the user may know what type of business to search for, but may not have a particular business in mind.

To conduct an online search for the business type, the user may turn to an online search provider, such as Google, Inc., that has previously aggregated business listings for various businesses. After sending a business search query to the online search provider, the user may receive a number of search results, which may be presented in a search result webpage or the like. The search result web page may include one or more business listings, which may list the businesses name, the businesses postal address, contact information for the business, or other such business information.

Because an online search provider is able to present many different businesses at once to a user, there may be a high degree of competition among businesses, especially where there is a high concentration of businesses of the same type in a geographic region. As businesses have learned that a user may typically seek out businesses that are geographically closer to him or her, a business may exploit an online search provider to take advantage of this fact. For example, a business may provide a false address to the online search provider such that when the business listing for the business appears in the search result webpage, the business listing may include the false address. The false address may entice the user into contacting the business and thereby may mislead the user away from choosing a business that is geographically closer to him or her. An online search provider has an interest in preventing these types of misleading business listings.

### BRIEF SUMMARY

An apparatus for verifying the authenticity of a potentially false business listing is provided. In one embodiment, the apparatus includes a memory operative to store a plurality of business listings and a processor in communication with the memory, the processor being operative to identify a selected one of the business listings as a potentially false business listing and transmit a request for a photograph of a business corresponding to the potentially false business listing. The processor may also be operative to obtain photographic business listing information from the requested photograph, compare the photographic business listing information with a portion of the potentially false business listing, and remove the potentially false business listing from the plurality of business listings when the photographic business listing information does not match the portion of the potentially false identified business listing.

In another embodiment of the apparatus, the potentially false business listing is associated with a business listing owner and the request for the photograph of the business is transmitted to the business listing owner.

In a further embodiment of the apparatus, the request for the photograph of the business includes a request for a photograph of the business storefront comprising the selected portion of the identified business listing.

In yet another embodiment of the apparatus, the processor is further operative to transmit a rejection of the photograph when the photograph does not comprise the portion of the potentially false business listing.

In yet a further embodiment of the apparatus, the processor is further operative to obtain the photographic business listing information from the requested photograph by receiving the requested photograph of the business, transmitting a copy of the requested photograph to an image recognition system, receiving the photographic business listing information from the image recognition system.

In another embodiment of the apparatus, the memory is further operative to store at least one matching parameter that determines whether the photographic business listing information matches the portion of the potentially false business listing.

In a further embodiment of the apparatus, the portion of the potentially false business listing includes a street address, and the at least one matching parameter defines that the photographic business listing information matches the portion of the potentially false business listing when the photographic business listing information includes the numerical portion of the street address.

In yet another embodiment of the apparatus, the portion of the potentially false business listing includes a business name, and the at least one matching parameter defines that the photographic business listing information matches the selected portion of the identified business listing when the photographic business listing information includes the business name.

In yet a further embodiment of the apparatus, the processor is further operative to identify the potentially false business listing as a verified business listing when the photographic business listing information matches the portion of the potentially false business listing.

In another embodiment of the apparatus, the processor is further operative to remove the potentially false business listing from the plurality of business listings when the requested photograph of the business has not been received after a predetermined time period has elapsed.

A method for verifying the authenticity of a potentially false business listing is also provided. In one embodiment, the method includes storing, in a memory, a plurality of business listings, identifying, with a processor in communication with the memory, a selected one of the business listings as a potentially false business listing, and transmitting a request for a photograph of a business corresponding to the potentially false business listing. The method may also include obtaining photographic business listing information from the requested photograph, comparing the photographic business listing information with a portion of the potentially false business listing, and removing the business listing from the plurality of business listings when the photographic business listing information does not match the portion of the potentially false business listing.

In another embodiment of the method, the potentially false business listing is associated with a business listing owner and the request for the photograph of the business is transmitted to the business listing owner.

In a further embodiment of the method, the request for the photograph of the business includes a request for a photograph of the business storefront that includes the portion of the potentially false business listing.

In yet another embodiment of the method, the method includes transmitting a rejection of the photograph when the photograph does not include the portion of the potentially false business listing.

In yet a further embodiment of the method, obtaining the photographic business listing information from the requested photograph includes receiving the requested photograph of the business, transmitting a copy of the requested photograph to an image recognition system, and receiving the photographic business listing information from the image recognition system.

In another embodiment of the method, the method includes storing, in the memory, at least one matching parameter that determines whether the photographic business listing information matches the portion of the potentially false business listing.

In a further embodiment of the method, the portion of the potentially false business listing includes a street address and the at least one matching parameter defines that the photographic business listing information matches the portion of the potentially false business listing when the photographic business listing information includes the numerical portion of the street address.

In yet another embodiment of the method, the portion of the potentially false business listing includes a business name, and the at least one matching parameter defines that the photographic business listing information matches the portion of the potentially false business listing when the photographic business listing information includes the business name.

In yet a further embodiment of the method, the method includes identifying the potentially false business listing as a verified business listing when the photographic business listing information matches the portion of the potentially false business listing.

In another embodiment of the method, the method includes removing the potentially false business listing from the plurality of business listings when the requested photograph of the business has not been received after a predetermined time period has elapsed.

### BRIEF DESCRIPTION OF THE DRAWINGS

FIG. 1 illustrates one example of an apparatus for verifying a business listing based on photographic business listing information obtained through image recognition.

FIG. 2 illustrates one example of a business listing server operative to verify a business listing based on photographic business listing information.

FIG. 3 illustrates one example of an alternative business listing server operative to verify a business listing based on photographic business listing information.

FIG. 4 illustrates one example of a business listing server obtaining photographic business listing information by leveraging an image recognition system.

FIGS. 5A-5B illustrate one example of logic flow for verifying a business listing based on photographic business listing information.

### DETAILED DESCRIPTION

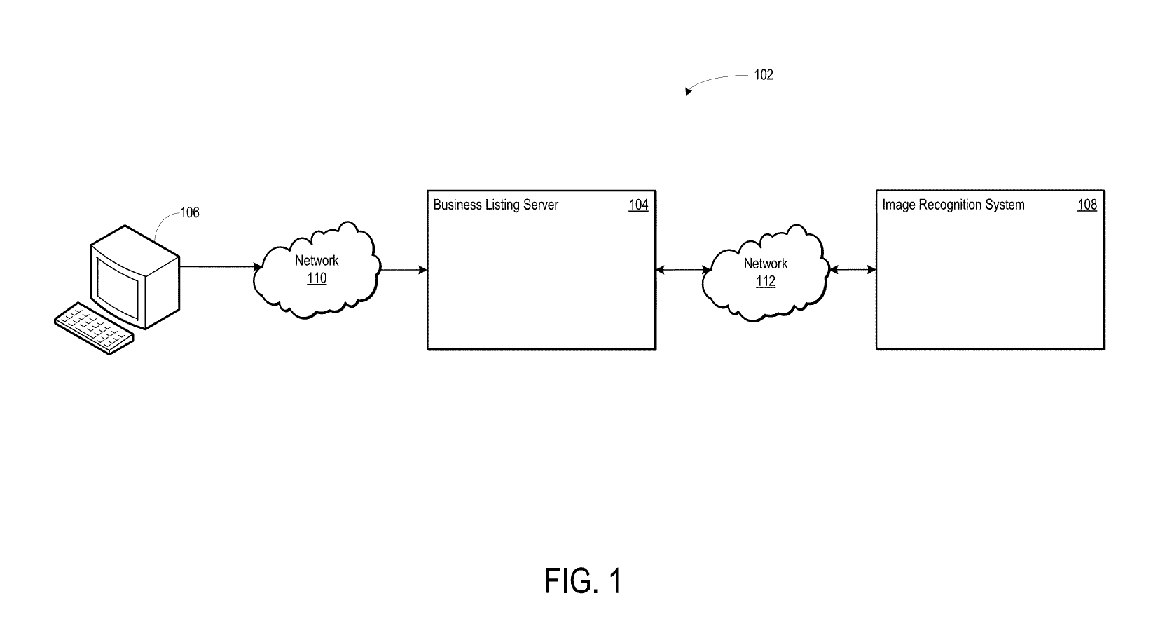

FIG. 1 illustrates one example of an apparatus 102 for verifying a business listing based on photographic business listing information obtained through image recognition. In one embodiment, the apparatus 102 may include a business listing server 104 in communication with an image recognition system 108 via a network 112. The business listing server 104 may also be in communication with a client device 106 via a network 110.

The client device 106 may include any type of client device, such as a desktop computer, a laptop computer, a smartphone, a table computer, or any other such client device. A user may communicate with the business listing server 104 via an application running or residing on the client device 106. One example of an application that a user may use is an Internet browser, such as Google Chrome, Mozilla Firefox, or any other such Internet browser, regardless of whether the Internet browser was designed for desktop or mobile computing.

The business listing server 104 is operative to verify one or more business listings residing on the business listing server 104. In one embodiment, verifying a business listing may include comparing information extracted from a photograph of the business with one or more portions of the corresponding business listing. The business listing server 104 may receive the photograph from the owner of the business via the client device 106, such as where the photograph is a digital photograph of the business. The business listing server 104 may also receive a physical photograph from the owner of the business listing.

In one embodiment, a business owner may establish a business listing account on the business listing server 104, and the business listing server 104 may request the photograph of the business at the time the business owner creates a business listing using the business listing account. In another embodiment, the business listing server 104 may establish a business listing for a business based on aggregated business information, such as information obtained from other online service providers, and a user may take ownership of the established business listing after authenticated that the user is, in fact, the owner of the business associated with the established business listing. In this embodiment, the business listing server 104 may request the photograph of the business after the user has authenticated that he or she is the owner of the business associated with the business listing.

In one embodiment, the business listing sever 104 may communicate with the image recognition system 108 to obtain photographic business listing information by which to verify the business listing. Accordingly, the image recognition system 108 may be operative to conduct image recognition on the photograph received by the business listing server 104. One example of an image recognition system 108 that may perform the image recognition on the photograph is “Free OCR,” which is available online and located at the Uniform Resource Locator of “www.free-ocr.com”.

In one embodiment, the image recognition system 108 may perform image recognition on a digital copy of the photograph received by the business listing server 104 to obtain the photographic business listing information. In another embodiment, the image recognition system 108 may perform image recognition on a physical photograph received by the business listing server 104 to obtain the photographic business listing information. The photographic business listing information may be communicated to the business listing server 104, which may use the photographic business listing information to verify the business listing corresponding to the business associated with the photograph.

Depending on the photographic business listing information obtained from the photograph, the business listing server 104 may take a number of actions with regard to the business listing associated with the photographic business listing information. As discussed below, the business listing server 104 may indicate to other users that the business listing is a verified business listing, may remove the business listing, may request that the business owner provide additional information or another photograph of the business, or other such actions.

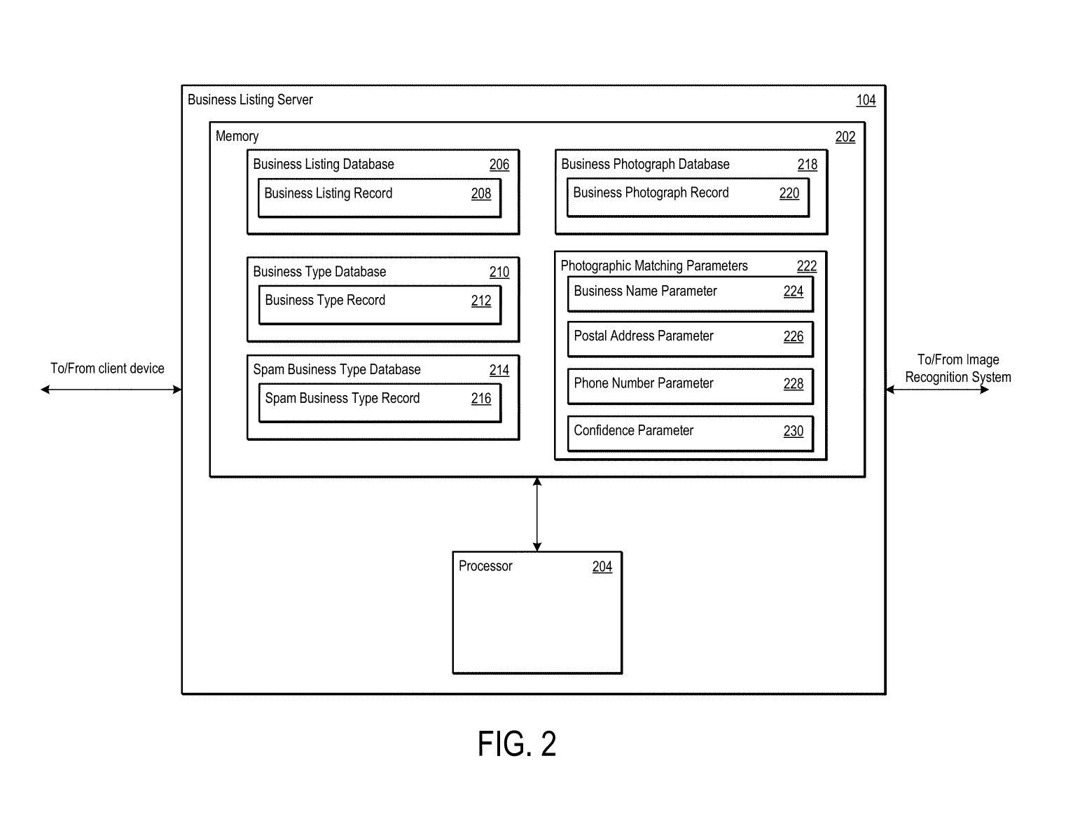

FIG. 2 illustrates one example of a business listing server 104 operative to verify a business listing based on photographic business listing information. The business listing server 104 may include a processor 204 in communication with a memory 202. The memory 202 may be operative to store one or more databases, such as a business listing database 206, a business type database 210, a spam business type database 214, and a business photograph database 218.

The memory 202 may be further operative to store one or more photographic matching parameters 222 for verifying a business listing. The photographic matching parameters 222 may include a business name parameter 224, a postal address parameter 226, a phone number parameter 228, and a confidence parameter 230. Other such parameters or combinations of the foregoing are also possible.

The business listing database 206 may include one or more business listing records 208. A business listing record 208 may include business listing information for a business listing. As previously discussed, the business listing record may be established when a user creates a business listing account with the business listing server 104 and thereafter creates a business listing for a business associated with the business listing account. Alternatively, the business listing server 104 may establish a business listing record for a business listing based on business listing information received from one or more information aggregation sources. The business listing record 208 may further be established based on combinations of the foregoing.

In general, a business listing describes business information about a business. A business listing may include may different types of information about the business, such as the business' title (e.g., corporate business name (“Google, Inc.”), informal business name (“Google”), etc.), the business' phone number, a URL for the business, a description of the business, or any other type of information about the business.

The business type database 210 may store business types for the business listings stored in the business listing database 206. The business type database 210 may include one or more business type records 212. A business type record 212 may identify a type of business. For example, a business type record 212 may identify a business as a law firm, a jewelry store, a grocery store, a supermarket, a shopping mall, a pet store, or any other type of business. The business type assigned to the business listing may or may not be displayed to a user when the business listing is presented to the user.

In one embodiment, the business listing server 104 may assign a business type to a business listing in the business listing database 206. For example, when the business listing server 104 aggregates business information about a business, the business listing server 104 may perform an automatic assignment of the business type based on one or more factors, such as the businesses' name or title, the businesses' location, or other such factors.

In another embodiment, the business listing server 104 may assign a business type to a business listing based on a mapping between a previously assigned business type residing in the aggregated business information and the business type stored in the business type database 210. For example, a business type record for “grocery store,” may have one or more mappings to other business types, such as “supermarket,” “convenience store,” “produce market,” or other similar business types. In this example and based on this mapping, when the business listing server 104 receives aggregated business information for a business, and one of the pieces of aggregated business information identifies the business listing as a “supermarket,” the business listing server 104 may then assign the business type of “grocery store” to the business listing.

In yet a further embodiment, a user may assign a business type to the business listing. For example, when a user establishes a business listing account with the business listing server 104, and thereafter creates a business listing for the user's business, the business listing server 104 may present one or more business types to the user for assigning to the created business listing. The user may then select one or more of these business types to assign to the created business listing.

The spam business type database 214 is operative to store one or more business types that are known to be spam business types. The spam business type database 214 may store one or more spam business type records 216. A spam business type record 216 may store a business type that is known to be a spam business type. As discussed above, a spam business type is a business type is usually associated with a business listing that a user creates in order to drive more consumers to his or her business, where the business listing contains purposefully false or inaccurate information. A typical spam business listing may include a false address such that users in proximity to the false address are drawn to the spam business listing and away from business listings that have correct addresses, but may be slightly further away. Other business information that a spam business listing may include may be a false business phone number, a false or misleading business name (e.g. a business named “Joe's” may be listed in the business listing as “Joe's Compare Best Jewelry Prices Lowest”), or any other type of false or misleading business.

The spam business type database 214 may store many different spam business types. For example, the spam business type database 214 may store a “jewelry” business type, a “law firm” business type, a “supermarket” business type, or any other spam business type. In one embodiment, the business listing server 104 may establish a spam business type record 216 based on one or more business listing records in the business listing database 206. In an alternative embodiment, the business listing server 104 may identify a business listing record in the business listing database 206 as a spam business type.

A business listing in the business listing database 206 may be identified as a potential spam business listing in any number of ways. In one embodiment, the business listing server 104 may automatically assign a business listing type from the business listing database 206 to the business listing, and the assigned business listing type may correspond to a spam business type identified in the spam business type database 214. In another embodiment, when a business listing is created, such as when a user creates a business listing, the user may assign a business listing type from the business type database 210 to the created business listing. In this embodiment, the user-assigned business listing type may correspond to a spam business type stored in the spam business type database 214. In yet a further embodiment, a spam business type may not have a corresponding type in the business type database 210. Hence, a business listing may be assigned a business type based on a business type stored in the business type database 210, a spam business type stored in the spam business type database 214, or combinations thereof.

The business photograph database 218 is operative to store one or more digital photographs of a business storefront. The one or more digital photographs may be stored as one or more business photograph records 220. The digital photographs may correspond to one or more business listings stored in the business listing database 206.

The business listing server 104 may use the digital photographs to verify the business information for a business listing stored in the business listing database 206. To this end, the business listing server 104 may request a photograph of a business storefront for a business corresponding to a business listing when a predetermined condition is satisfied. In one embodiment, the predetermined condition may be satisfied when the business type assigned to the business listing is a spam business type. In this embodiment, when the business listing server 104 identifies that a business listing has been assigned a business type that corresponds to a spam business type, the business listing server 104 may communicate a request for a photograph of a business corresponding to the business listing. As discussed further below, the business listing server 104 may use the photograph to verify one or more aspects of the business listing information.

For example, suppose that a user creates a new business listing and the business listing is assigned a business listing type of “jewelry store.” In this example, the business listing server 104 may cross-reference the spam business type database 214 to determine whether the business type “jewelry store” is a spam business type. If the business listing server 104 determines that the “jewelry store” business type is a spam business type, the business listing server 104 may communicate a request to the user for a photograph of the business storefront. The business listing server 104 may communicate the request electronically (e.g., e-mail, instant messaging, etc.), telephonically, by mail, or by combinations thereof.

The request for the photograph of the business storefront may be based on the information contained in the business listing. For example, in the request for the photograph of the business storefront, the business listing server 104 may request that the owner of the business or user associated with the business listing account capture a photograph of the business storefront that includes information in the business listing. In this example, where the business listing includes address information (e.g., a postal address), a business title, a business phone number, or other such business information, the business listing server 104 may request that the photograph of the business storefront includes one or more of these fields.

Suppose that the business listing includes a populated business title of “Joe's Warehouse” and a populated postal address of “123 Main Street.” The business listing server 104 may request that the photograph of the business storefront include the business name of “Joe's Warehouse” and the numerical portion of the postal address (i.e., “123”). Should the business listing of “Joe's Warehouse” also include a business phone number, the business listing server 104 may further request that the photograph of the business storefront include a displayed phone number. Of course, it should be understood that not all businesses display such information, and, as discussed below, the business listing server 104 may account for these differences by leveraging one or more photographic matching parameters 222.

In the example above, the request for the photograph of the business storefront may be communicated to the user that created the business listing. Alternatively, the request for the photograph may be communicated to a user that confirms ownership of the business listing. For example, as discussed previously, the business listing server 104 may establish a business listing based on business information collected from one or more information aggregation sources. In this example, when the business listing server 104 makes the business listing publicly accessible, the business listing server 104 may also include information about how the owner of the business may claim ownership of the business listing. For example, the business listing server 104 may include a hyperlink in the business listing that links to online instructions as to how the business owner may establish ownership of the business listing. Based on these instructions, when the owner establishes ownership of the business listing, the business listing server 104 may then communicate a request to the owner of the business listing for the photograph of the business storefront.

The business listing server 104 may be operative to receive a photograph of the business storefront regardless of the format of the photograph. For example, the business listing server 104 may receive a physical photograph of the business storefront and then use one or more scanning technologies to convert the physical photograph into a digital photograph for storing in the business photograph database 218. Further still, the business listing server 104 may receive a digital photograph of the business storefront via e-mail or the like, and then store the digital photograph in the business photograph database 218.

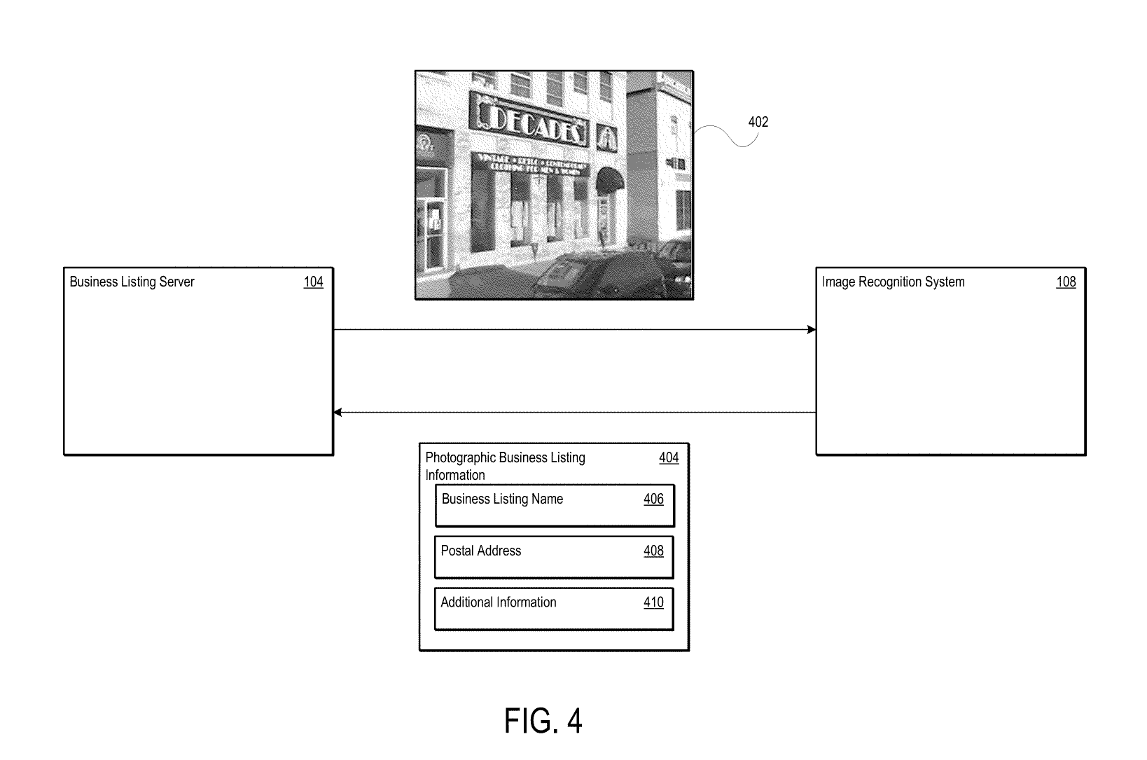

As mentioned above, the business listing server 104 may use the photograph of the business storefront to verify the business listing. The business listing server 104 may employ image recognition techniques to deconstruct the photograph of the business storefront and use the resulting photographic business listing information to verify the accuracy of the business information contained in the business listing. FIG. 4 illustrates one example of the business listing server 104 obtaining photographic business listing information 404 by leveraging an image recognition system 108. In one embodiment, the business listing server 104 may communicate a photograph 402 of the business storefront to the image recognition system 108 electronically, such as via e-mail, over a network, a File Transfer Protocol (“FTP”), or the like. The image recognition system 108 may then perform image recognition on the photograph 402 using image recognition techniques, such as optical character recognition or the like. As mentioned previously, one example of an image recognition system 108 that may perform the image recognition on the photograph 402 may be the OCR system available via “www.free-ocr.com”.

The image recognition system 108 may then communicate the photographic business listing information 404 to the business listing server 104. The photographic business listing information 404 may be based on text or other alphanumeric characters appearing in the photograph 402. In one embodiment, the image recognition system 108 may classify the alphanumeric characters of the photographic business listing information 404 into various parameters 406-410. The parameters 406-410 of the photographic business listing information 404 may include a business listing name parameter 406, a postal address parameter 406, and an additional information parameter 410, which may be business information not classified as either a business listing name or postal address. Of course, other parameters are also possible, such as a phone number parameter, a business type parameter, other such parameters or combinations thereof. The values of the photographic business listing information parameters 406-410 may be populated with one or more alphanumeric characters extracted from the photograph 402 of the business storefront.

Alternatively, the image recognition system 108 may communicate the one or more alphanumeric characters to the business listing server 104, and the business listing server 104 may arrange or classify the alphanumeric characters into the one or more photographic business listing information parameters 406-410. In one embodiment, the business listing server 104 may arrange or classify the alphanumeric characters into the one or more photographic business listing information parameters 406-410 by comparing the alphanumeric characters received by the image recognition system 108 with the business information for the business listing.

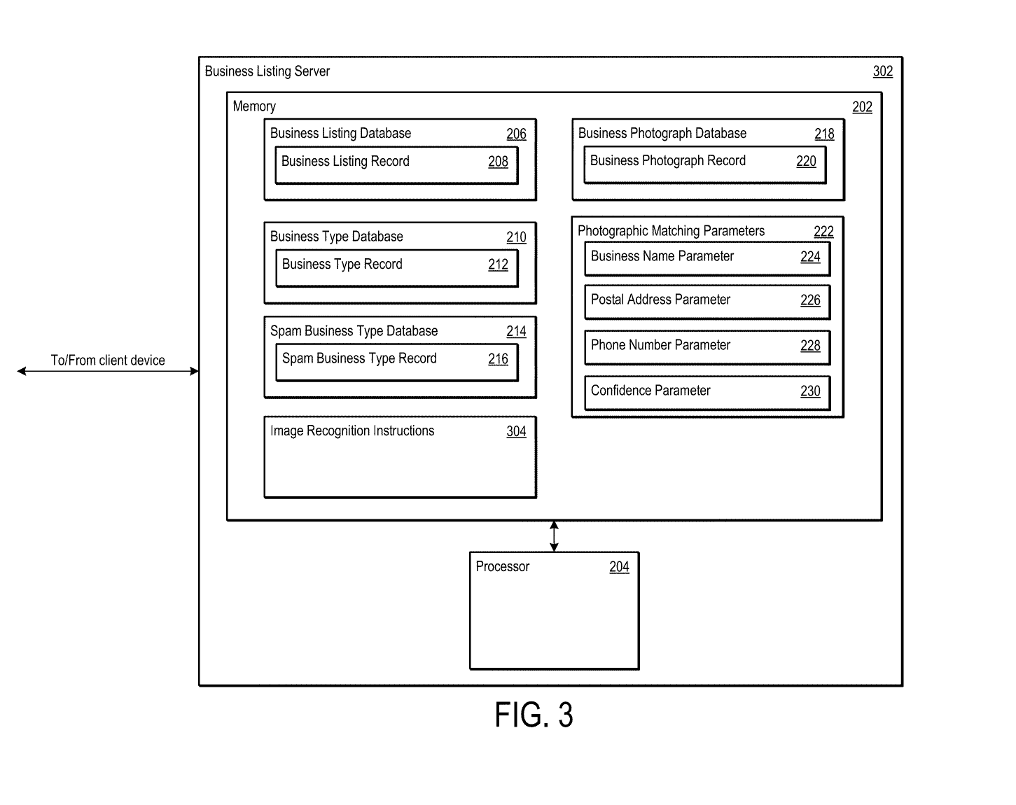

FIG. 3 illustrates an alternative arrangement of a business listing server 302 for verifying a business listing. In the alternative arrangement shown in FIG. 3, the business listing server 302 may include image recognition instructions 304 operative to instruct the processor 206 how to perform image recognition techniques on the received photograph 402 of the business storefront. Hence, the business listing server 104 and/or the business listing server 302 may leverage image recognition techniques for extracting the photographic business information 404 from the photograph 402 of the business storefront regardless of whether the image recognition is performed internal or external to the business listing server 104 or the business listing server 302.

To determine whether the photograph of the business storefront includes sufficient information to verify the accuracy of the business listing, the business listing server 104 may include photographic matching parameters 222, which may instruct the business listing server 104 as to whether there is a sufficient match between the photographic business listing information 404 and the business information contained within the business listing.

In one embodiment, the photographic matching parameters 222 may include a business name parameter 224, a postal address parameter 226, a phone number parameter 228, and a confidence parameter 230. The business name parameter 224 may establish a threshold for the number of matching characters in the business listing name parameter 406 of the photographic business listing information 404 and the business name appearing in the corresponding business listing. For example, the business name parameter 224 may establish a percentage of matching characters (e.g., 70%) or a specific number (e.g. five characters) of matching characters for there to be a match between the business listing name parameter 406 and the business name in the business listing. Under this example, if the business name in the business listing is “Joe's Warehouse” and the value of the business listing name 406 parameter is “40e's W@reh0use,” the business listing server 104 would establish that there is a match between the value of the business listing name parameter 224 and the business listing name.

The other photographic matching parameters 222 may establish similar thresholds. For example, the postal address parameter 226 may establish a threshold, such as a percentage or specific number, for the number of matching characters in the postal address parameter 408 of the photographic business listing information 404 and the postal address appearing in the corresponding business listing. As another example, the phone number parameter 228 may also establish a threshold, such as a percentage or specific number, for the number of matching characters in a phone number identified in the photographic business listing information 404 and the business phone number appearing in the corresponding business listing.

In an alternative embodiment, the photographic matching parameters 222 may indicate the percentage or specific number of matching characters in the parameters 406-410 of the photographic business listing information 404 and the corresponding characters appearing in the business listing. Hence, the photographic matching parameters 222 may not necessarily be thresholds, but may indicate the degree of similarity between the information appearing the photograph 402 and the information contained with the corresponding business listing.

The confidence parameter 230 may indicate a degree of confidence that the business listing information for the business listing is accurate. In one embodiment, the confidence parameter 230 may be based on whether one or more of the photographic matching parameters 224-228 were met. For example, the confidence parameter 230 may indicate that the business name parameter 224 and the postal address parameter 226 were met, but that the phone number parameter 228 was not met.

In another embodiment, the confidence parameter 230 may be based on a weighted average of the degree of similarity between the parameters used to establish whether there is a match between the business listing information and the photographic business listing information 404. For example, suppose that the business listing server 104 establishes that there is a 65% match in the business name, an 80% match in the postal address, and a 0% match in the phone number. The confidence parameter 230 may be determined by computing a weighted average of 65%, 80% and 0%. Should each of these parameters be given the same weight, the confidence parameter 230 may yield that there is a 48.3% confidence that the business listing information is accurate. However, the business listing server 104 may be configurable such that one parameter, such as the postal address, may be given more weight than another parameter, such as the phone number.

In yet a further embodiment, the confidence parameter 230 may establish a threshold for determining whether the business listing information for the business listing is accurate. In this embodiment, a weighted average may be computed from each of the photographic matching parameters 222, and this weighted average may be compared against the confidence parameter 230. Should the weighted average meet or exceed the confidence parameter 230, the business listing server 104 may determine that the business listing information is accurate and that the business listing is verified.

The business listing server 104 may take one or more actions for a business listing depending on whether the corresponding business listing information is determined as being accurate. As discussed previously, the accuracy of the corresponding business listing information may be based on a corresponding confidence parameter 230. In one embodiment, the business listing may be flagged or marked for moderation, such that a user or operator that interacts with the business listing server 104 is requested to review the business listing. The request for moderation may be employed where the confidence parameter 230 is used as a threshold to gauge the accuracy of the business listing information.

In another embodiment, the confidence parameter 230 may be displayed along or in-line with the business listing information. In this manner, a user that views the business listing may be able to ascertain for himself or herself whether the business listing is trustworthy.

In yet another embodiment, the business listing server 104 may remove or prevent the display of the business listing. In this embodiment, the business listing information may remove or prevent the display of the business listing when the confidence parameter 230 indicates that the business listing information is not accurate.

Moreover, the business listing server 104 may indicate whether a business listing is accurate. For example, the business listing server 104 may flag or mark the business as being verified when the confidence parameter 230 indicates that the business listing information is accurate. In this manner, when a user views the business listing, the user may see words or graphics that indicate the business listing is a verified business listing. Of course, in an alternative embodiment, the verification of the business listing may be for internal use by the business listing server 104, such as auditing, and the verification status of the business listing may not be displayed to a user. Combinations of the foregoing are also possible.

Furthermore, the business listing server 104 may be responsive to situations where the photographic business listing information 404 is unintelligible, incomplete, or does not match any of the business information contained in the corresponding business listing. In one embodiment, the image recognition system 108 may inform the business listing server 104 that the image recognition system 108 was unable to extract any meaningful information from the photograph of the business storefront. In this embodiment, the business listing server 104 may send an additional request to the user associated with the business listing or the owner of the business to provide an additional or secondary photograph of the business storefront.

Similarly, should the extracted photographic business listing information not match any of the business information in the corresponding business listing, or the confidence parameter 230 falls below a given threshold, the business listing server 104 may notify the user associated with the business listing or the owner of the business of this fact. The business listing server 104 may then send an additional request for a secondary or additional photograph of the business storefront.

The business listing server 104 may be further configured to work with unresponsive users to requests for the photograph of the business storefront. In one embodiment, the business listing server 104 may be configured with a predetermined time period in which the business listing server 104 expects to receive a photograph of the business storefront. The predetermined time period may be any measurement of time, such as hours, days, weeks, months, or any other measurement of time. Should the predetermined time period elapse and the business listing server 104 has not yet received the photograph of the business storefront, the business listing server 104 may send an additional request for the photograph of the business storefront. The business listing server 104 may be configured to send a predetermined number of repeat requests for the photograph of the business storefront before the business listing server 104 stops sending requests.

Where the user associated with the business listing or the owner of the business is unresponsive to the repeated requests for the photograph, the business listing server 104 may remove the business listing from the business listing database 206. The business listing server 104 may further notify the user associated with the business listing or the owner of the business regarding this failure. Although the business listing server 104 may be configured to send repeat requests for the photograph, the business listing server 104 may also be configured not to send repeat requests for the photograph of the business storefront. In this manner, the business listing server 104 provides the unresponsive user or owner with the opportunity to submit a photograph of his or her business to verify the accuracy of the business listing information.

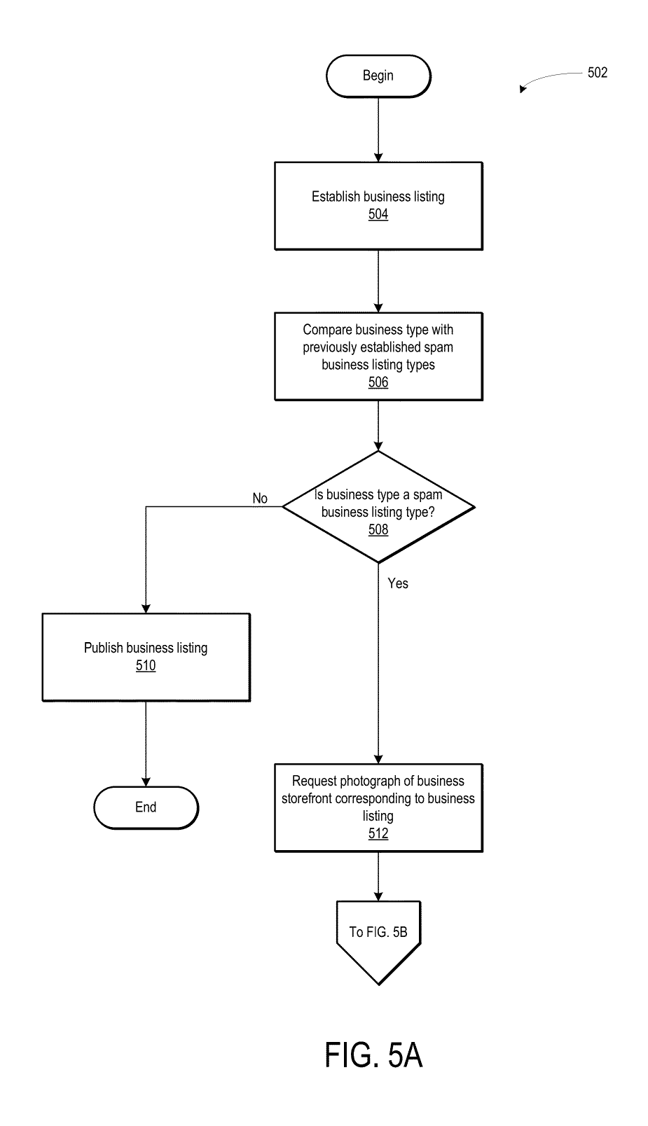

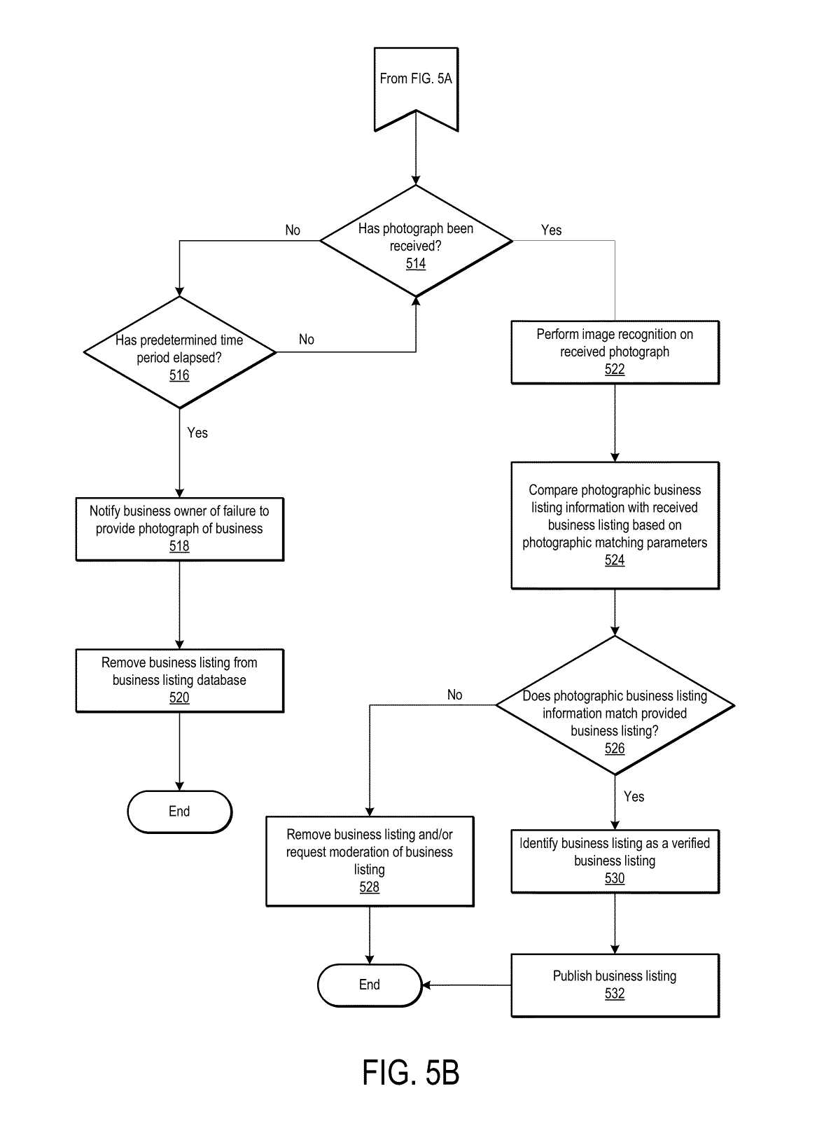

FIGS. 5A-5B illustrate one example of logic flow 502 for verifying a business listing based on photographic business listing information. Initially, the business listing server 104 may establish a business listing (Block 504). As previously discussed, the business listing may be established by a user interacting with the business listing server 104 or the business listing server 104 may establish a business listing for a business based on business information collected from one or more aggregation sources.

The business listing server 104 may receive a business type for assigning to the business listing, or the business listing server 104 may assign a business type to the business listing. The business listing server 104 may compare the assigned business type of the business listing with the business types the business listing server 104 has identified as spam business listing types (Block 506 and Block 508). As previously discussed, the business listing server 104 may maintain a spam business type database 214 containing previously identified spam business types.

Depending on the business type comparison, the business listing server 104 may take one or more actions. Where the business type of the business listing is not a spam business listing type, the business listing server 104 may simply publish the business listing (Block 510). Publishing the business listing may include making the business publicly available for viewing by one or more users.

However, should the business listing server 104 identify the business type of the business listing as a spam business listing type, the business listing server 104 may send a request for a photograph of the business storefront (Block 512). As previously discussed, the request for the photograph may be sent to the user associated with the business listing, such as by being sent to an e-mail address associated with the user. The request may be sent to more than just the user associated with the business listing; for example, the request may be sent to the owner of the business. Moreover, should the business listing be established automatically by the business listing server 104, the business listing server 104 may send the request to the owner of the business once the owner has verified that he or she is, in fact, the owner of the business.

After sending the request, the business listing server 104 may then wait for a response from the user or the owner for the photograph (Block 514). The business listing server 104 may further wait for a predetermined time period to receive a response (Block 516). Should the predetermined time period elapse and the business listing server 104 has not yet received a photograph of the business storefront, the business listing server 104 may notify the user or business owner of the failure to provide the photograph (Block 518), and then the business listing server 104 may remove the business listing from the business listing database 206 (Block 520). Of course, the business listing server 104 may also send a repeat request to the user or the business owner to give them a further opportunity to respond.

Should the business listing server 104 receive a response that includes the requested photograph, the business listing server 104 may then perform image recognition on the photograph to obtain the previously discussed photographic business listing information 404 (Block 522). The business listing server 104 may conduct its own image recognition on the photograph, may communicate the photograph to an image recognition system 108 for conducting image recognition on the photograph, or may perform a combination of the two.

Once the business listing server 104 has obtained the extracted photographic business listing information 404, the business listing server 104 may then compare the photographic business listing information 404 with the business information contained in the corresponding business listing (Block 524). As previously discussed, the business listing server 104 may leverage one or more photographic matching parameters 222 in determining whether the extracted photographic business listing information 404 matches the business information contained in the business listing.

The business listing server 104 may then determine whether the extracted photographic business listing information 404 matches the business information contained in the business listing (Block 526). As discussed above, the business listing server 104 may employ a confidence parameter 230 to determine whether the extracted photographic business listing information 404 matches the business information in the business listing. Should the business listing server 104 determine that the extracted photographic business listing information 404 does not match the business information in the corresponding business listing, the business listing server 104 may remove the business listing from the business listing database 206 (Block 528). Alternatively, or in addition, the business listing server 104 may request moderation of the business listing when the extracted photographic business listing information 404 does not match the business information for the corresponding business listing (Block 528). The business listing server 104 may further notify the user associated with the business listing or the business owner that the photograph of the business storefront does not contain information that matches the business information for the corresponding business listing.

However, should the business listing server 104 determine that the photographic business listing information 404 matches the business information in the corresponding business listing, the business listing server 104 may identify the corresponding business listing as a verified business listing (Block 530). The business listing server 104 may then publish the verified business listing and make the verified business listing publicly viewable (Block 532). In a further embodiment, the business listing server 104 make also publish the verified status of the business listing to indicate to other users that the business information in the business listing is particularly trustworthy.

In this manner, the business listing server 104 facilitates the verification of business listings that may be associated with one or more known spam business types. Since a user may create multiple spam business listings for the same business, the business listing server 104 ensures that the business listing information is accurate by requiring a photograph of the business. In addition, because the business listing server 104 requires verification of a business listing associated with a known spam business listing type, when the business listing is verified, users can be assured that the business information contained in the business listing is accurate. Hence, the business listing server 104 provides a safeguard to users who know what business type they are searching for, but who may not know the name of a particular business.

The business listing server 104 described above may be implemented in a single system or partitioned across multiple systems. In addition, the memory 202 may be distributed across many different types of computer-readable media. The memory 202 may include random access memory (“RAM”), read-only memory (“ROM”), hard disks, floppy disks, CD-ROMs, flash memory or other types of computer memory.

The business listing database 206, the business type database 210, the spam business type database 214, the business photograph database 218, the photographic matching parameters 222, and the image recognition instructions 304 may be implemented in a combination of software and hardware. For example, the photographic matching parameters 222 or the image recognition instructions 304 may be implemented in a computer programming language, such as C# or Java, or any other computer programming language now known or later developed. The photographic matching parameters 222 or the image recognition instructions 304 may also be implemented in a computer scripting language, such as JavaScript, PHP, ASP, or any other computer scripting language now known or later developed. Furthermore, the photographic matching parameters 222 or the image recognition instructions 304 may be implemented using a combination of computer programming languages and computer scripting languages.

In addition, the business listing server 104 may be implemented with additional, different, or fewer components. As one example, the processor 204 and any other logic or component may be implemented with a microprocessor, a microcontroller, a DSP, an application specific integrated circuit (ASIC), discrete analog or digital circuitry, or a combination of other types of circuits or logic. The business listing database 206, the business type database 210, the spam business type database 214, the business photograph database 218, the photographic matching parameters 222, and the image recognition instructions 304 may be distributed among multiple components, such as among multiple processors and memories, optionally including multiple distributed processing systems.

Logic, such as programs, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

The business listing database 206, the business type database 210, the spam business type database 214, and the business photograph database 218 may be stored as a collection of data. For instance, although the business listing database 206, the business type database 210, the spam business type database 214, and the business photograph database 218 are not limited by any particular data structure, the business listing database 206, the business type database 210, the spam business type database 214, and the business photograph database 218 may be stored in computer registers, as relational databases, flat files, or any other type of database now known or later developed.

The networks 110-112 may be implemented as any combination of networks. As examples, the networks 110-112 may be a Wide Area Network (“WAN”), such as the Internet; a Local Area Network (“LAN”); a Personal Area Network (“PAN”), or a combination of WANs, LANs, and PANs. Moreover, the network 112 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

Interfaces between and within the business listing server 104 may be implemented using one or more interfaces, such as Web Services, SOAP, or Enterprise Service Bus interfaces. Other examples of interfaces include message passing, such as publish/subscribe messaging, shared memory, and remote procedure calls.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims. Furthermore, while certain operations and functions are shown in a specific order, they may be performed in a different order unless it is expressly stated otherwise.

1. An apparatus for verifying the authenticity of a potentially false business listing, the apparatus comprising:
a memory operative to store a plurality of business listings; and
a processor in communication with the memory, the processor being operative to:
identify a selected one of the business listings as a potentially false business listing;
transmit a request for a photograph of a business corresponding to the potentially false business listing;
obtain photographic business listing information from the requested photograph;
compare the photographic business listing information with a portion of the potentially false business listing; and
remove the potentially false business listing from the plurality of business listings when the photographic business listing information does not match the portion of the potentially false identified business listing.

2. The apparatus of claim 1, wherein the potentially false business listing is associated with a business listing owner and the request for the photograph of the business is transmitted to the business listing owner.

3. The apparatus of claim 1, wherein the request for the photograph of the business comprises a request for a photograph of the business storefront comprising the selected portion of the identified business listing.

4. The apparatus of claim 3, wherein the processor is further operative to transmit a rejection of the photograph when the photograph does not comprise the portion of the potentially false business listing.

5. The apparatus of claim 1, wherein the processor is further operative to obtain the photographic business listing information from the requested photograph by:
receiving the requested photograph of the business;
transmitting a copy of the requested photograph to an image recognition system; and
receiving the photographic business listing information from the image recognition system.

6. The apparatus of claim 1, wherein the memory is further operative to store at least one matching parameter that determines whether the photographic business listing information matches the portion of the potentially false business listing.

7. The apparatus of claim 6, wherein:
the portion of the potentially false business listing comprises a street address; and
the at least one matching parameter defines that the photographic business listing information matches the portion of the potentially false business listing when the photographic business listing information comprises the numerical portion of the street address.

8. The apparatus of claim 6, wherein:
the portion of the potentially false business listing comprises a business name; and
the at least one matching parameter defines that the photographic business listing information matches the selected portion of the identified business listing when the photographic business listing information comprises the business name.

9. The apparatus of claim 1, wherein the processor is further operative to identify the potentially false business listing as a verified business listing when the photographic business listing information matches the portion of the potentially false business listing.

10. The apparatus of claim 1, wherein the processor is further operative to remove the potentially false business listing from the plurality of business listings when the requested photograph of the business has not been received after a predetermined time period has elapsed.

11. A method for verifying the authenticity of a potentially false business listing, the method comprising:
storing, in a memory, a plurality of business listings;
identifying, with a processor in communication with the memory, a selected one of the business listings as a potentially false business listing;
transmitting a request for a photograph of a business corresponding to the potentially false business listing;
obtaining photographic business listing information from the requested photograph;
comparing the photographic business listing information with a portion of the potentially false business listing; and
removing the business listing from the plurality of business listings when the photographic business listing information does not match the portion of the potentially false business listing.

12. The method of claim 11, wherein the potentially false business listing is associated with a business listing owner and the request for the photograph of the business is transmitted to the business listing owner.

13. The method of claim 11, wherein the request for the photograph of the business comprises a request for a photograph of the business storefront comprising the portion of the potentially false business listing.

14. The method of claim 13, further comprising transmitting a rejection of the photograph when the photograph does not comprise the portion of the potentially false business listing.

15. The method of claim 1, obtaining the photographic business listing information from the requested photograph comprises:
receiving the requested photograph of the business;
transmitting a copy of the requested photograph to an image recognition system; and
receiving the photographic business listing information from the image recognition system.

16. The method of claim 11, further comprising storing, in the memory, at least one matching parameter that determines whether the photographic business listing information matches the portion of the potentially false business listing.

17. The method of claim 16, wherein:
the portion of the potentially false business listing comprises a street address; and
the at least one matching parameter defines that the photographic business listing information matches the portion of the potentially false business listing when the photographic business listing information comprises the numerical portion of the street address.

18. The method of claim 16, wherein:
the portion of the potentially false business listing comprises a business name; and
the at least one matching parameter defines that the photographic business listing information matches the portion of the potentially false business listing when the photographic business listing information comprises the business name.

19. The method of claim 11, further comprising identifying the potentially false business listing as a verified business listing when the photographic business listing information matches the portion of the potentially false business listing.

20. The method of claim 11, further comprising removing the potentially false business listing from the plurality of business listings when the requested photograph of the business has not been received after a predetermined time period has elapsed.
